(19) United States
(12) Patent Application Publication
(10) Pub. No.: US 2011/0121925 A1
(43) Pub. Date: May 26, 2011

(54) SWITCHING DEVICE FOR A VEHICLE HAVING AN ELECTRONIC IMMOBILIZER AND METHOD FOR ACTIVATING AN ELECTRONIC IMMOBILIZER

(75) Inventors: Ulrich Emmerling, Kelheim (DE); Herbert Froitzheim, Pettendorf (DE); Klaus Hainzlmeier, Kelheim (DE); Stefan Hermann, Kofering (DE)

(73) Assignee: CONTINENTAL AUTOMOTIVE GMBH, MÜNCHEN (DE)

(21) Appl. No.: 13/001,817

(22) PCT Filed: Jul. 29, 2009
(86) PCT No.: PCT/EP2009/059814

§ 371 Date: Dec. 29, 2010

(30) Foreign Application Priority Data
Jul. 29, 2008 (DE) 10 2008 035 243.8

(51) Int. Cl. H01H 50/44

(52) U.S. Cl. 335/2

(57) ABSTRACT

A switching device for a vehicle having an electronic immobilizer includes at least one part which is fixedly mounted in relation to the vehicle and at least one sensing device which can move relative to the fixedly mounted part. The switching device further includes at least one induction coil which is provided for communication with a transponder that is integrated into a portable device. The induction coil is at least partially integrated into the movable sensing device.

The invention relates to a switching device for a vehicle with an electronic immobilizer, wherein an authorization by means of an electronic ID code is required for actuating the electronic immobilizer. It further relates to a method for the actuation of such an electronic immobilizer.

DE 44 35 894 C2 discloses an electronic security system for a motor vehicle, in which, to deactivate an immobilizer, a transponder accommodated in a portable device communicates with a control device of the security system and transmits an identification code.

U.S. Pat. No. 7,187,266 B2 discloses a similar arrangement in which the transponder can be powered both via a separate battery and also inductively via an induction coil arranged in a switching device.

With these types of system a switching device is provided which a user actuates for example when putting the vehicle into service. Actuation of a sensing device of the switching device causes current to flow into an induction coil for transmission of energy and/or request signals to the transponder assigned for example to a key carried by the user. The transponder then transmits an identification code which is received by a receiver unit of the vehicle, decoded by the control unit and then checked to ensure that it matches a stored identification code. If it does, the electronic immobilizer is deactivated and the engine ignition may be operated.

The object of the present invention is to provide alternatives to known switching devices which especially make it possible to cleverly accommodate the required individual components within a small space and ensure a good and rapid communication between the transponder of the portable device and a control device installed in the vehicle.

This object is achieved inventively with the subject matter of the independent claims. Advantageous embodiments are the subject matter of the subclaims.

In accordance with an aspect of the present invention a switching device for a vehicle with an electronic immobilizer has at least one part mounted fixedly in relation to the vehicle and at least one sensing device which can move relative to the fixedly mounted part. The part mounted fixedly in relation to the vehicle is for example connected rigidly to a surrounding housing and is integrated into a dashboard or separately in the vicinity of the steering wheel of the vehicle. The sensing device which can move is typically supported movably relative to the fixedly mounted part within the housing, especially displaceably. By actuating this sensing device the operator starts the authentication process described above.

The switching device further features at least one induction coil provided for communication with a transponder integrated into a portable device, with the induction coil being integrated at least partly in the sensing device which can move.

Communication between the induction coil and the transponder is to be understood both here and in the following text as both the transmission of useful signals and also the transmission of energy to supply the transponder. Expediently communication is undertaken such that the actuation of the sensing device is interrogated at cyclic intervals or that it actively generates a signal which triggers a supply of energy to the transponder through the induction coil. In the following text the induction coil then serves to transmit and receive useful signals from or to the transponder.

An at least partial integration of the induction coil into the movable sensor device is understood to be an arrangement in which the at least one component of the coil, for example a coil body or coil core, is connected rigidly to the sensing device which can move so that it moves along with it on activation.

In accordance with a form of embodiment the coil has a coil core and a coil bobbin with windings, with the coil core being integrated into the sensing device which can move and the coil bobbin into the fixedly mounted part. In this case a coil bobbin with windings is also understood as a form of embodiment in which no actual carrier body is present but the coil is embodied as an air coil the core body of which merely features the windings.

As an alternative the coil bobbin can also be integrated into the sensing device which can move and the coil core into the fixedly mounted part.

The coil core is embodied as a ferrite core for example.

In a development of the invention the coil core and the coil bobbin are arranged in relation to one another such that the immersion depth of the coil core into the coil bobbin changes with the movement of the sensing device. This can be undertaken by the coil core not being completely immersed into the coil bobbin in the non-actuated initial position of the sensing device but being plunged in the actuated position. In such an arrangement the inductance of the coil changes particularly greatly on actuation of the sensing device, so that the sensing device actuation can be detected from this.

In a form of embodiment at least one first induction coil and one second induction coil are provided for, with the first induction coil being integrated into the fixedly mounted part and being powered via an electronic contact, while the second induction coil is integrated into the sensing device which can move and is able to be powered through the first induction coil.

In this form of embodiment the first coil to be easily powered serves to transmit signals to the second coil and from the second coil while only the second coil communicates directly with the transponder. This has the advantage that the second coil communicating with the transponder can also be arranged in the sensing device which can move and in any event at a point at which communication with the transponder is especially favorable, taking into consideration the distance and the geometrical field strength distribution. For this account is taken of the fact that power is not supplied directly to the second coil but inductively by the first coil.

In this type of arrangement the first induction coil and the second induction coil can have a common coil core.

In one embodiment the induction coil is integrated completely into the sensing device which can move and has energy supplied to it via at least one sliding contact. With this embodiment too the problem of supplying power to the induction coil which is accommodated in the sensing device which can move must be resolved. Power is not supplied inductively here but via a sliding contact. In this form of embodiment the sliding contact can typically be designed such that an electrical connection is only made at all on actuation of the sensing device or at least so that the electrical resistance at the sliding contact changes significantly on actuation of the sensing device so that a resistance measurement can be used for detection of sensing device actuation.

In a further form of embodiment the induction coil is integrated into the sensing device which can move and has energy supplied to it via flexible leads. In this way too the supply of power to the induction coil can be ensured although said coil is housed in the sensing device which can move. With these forms of embodiment too the induction coil can have a coil core and a coil bobbin with windings.

In one form of embodiment the coil bobbin is embodied as a spring, the resetting force of which moves the sensing device which can move after its actuation back into an initial position. In this case a coil core can also be provided which is arranged within a spring, for example a spring in the form of a helix. In this case too the arrangement can be designed such that the inductance of the induction coil changes measurably with the compression of the spring on actuation of the sensing device, so that this can be used for detection of a sensing device actuation.

This form of embodiment has the advantage that the movement of the spring as a coil makes it possible to save on one component, namely a coil to be provided separately. This reduces the costs for the switching device and in addition also saves space.

In accordance with a further aspect of the invention a switching device for a vehicle with an electronic immobilizer has at least one part mounted fixedly in relation to the vehicle and at least one sensing device which can move relative to the fixedly mounted part. It further comprises at least one induction coil provided for communication with a transponder integrated into a portable device, with a section of the sensing device which can move surrounding the fixedly mounted part and the induction coil being integrated into the fixedly mounted part.

In such an arrangement the power can be supplied to the induction coil in an especially simple design, with however a great freedom of arrangement and alignment of the induction coil being simultaneously retained. For example an axis of symmetry of the induction coil can be aligned essentially parallel or at right angles to the direction of movement of the sensing device which can move.

The arrangement also has the advantage of taking up a particularly small amount of space.

In accordance with a further aspect of the invention a switching device for a motor vehicle with an electronic immobilizer has at least one part mounted fixedly in relation to the vehicle and at least one sensing device which can move relative to the fixedly mounted part. In addition it comprises at least one induction coil provided for communication with a transponder integrated into a portable device, with the induction coil, the fixedly mounted part and the sensing device which can move being integrated into a common housing and the induction coil being arranged next to the fixedly mounted part and the sensing device which can move.

In this case an arrangement of the coil is also to be understood, in addition to the fixedly mounted part and the sensing device which can move, as an arrangement in which the induction coil is disposed in the installed state above or below and in any event in the immediate vicinity of the fixedly mounted part and the sensing device.

This arrangement has the advantage of allowing an even greater degree of freedom to be obtained for the arrangement of the coil, but simultaneously not giving up the integration in a common housing, so that the entire switching device is able to be fitted as a module.

The movable sensor can be embodied so that through its movement a switch for supplying the induction coil with energy is able to be actuated. In this case the actuation of the sensing device is not detected or is not only detected via an inductance or resistance measurement but mechanically via the actuation of the switch.

The movable switch is advantageously spring-loaded in its actuation position so that after actuation it is returned to its non-actuated initial position.

The switching device can also have lateral guides for the movable sensing device which guide the sensing device in its movement from the initial position into the actuated position and back again.

The switching device is used in the electronic immobilizer of a vehicle or in a comparable security system. It makes it possible to reduce the amount of space required for the switching device without reducing the size of the sensing device at the same time and thereby degrading operability, since the induction coil is integrated in a space-saving manner into the sensing device. In addition a great freedom of design now exists for the arrangement and alignment of the coils so that for example a disadvantageous coupling with metallic elements in the vicinity of the coil, such as chrome rings used as design elements, can be avoided.

In accordance with one aspect of the invention, in a method for actuating an electronic immobilizer of a vehicle including the switching device described, an actuation of the movable sensing device of the switching device is determined from a measurement of the change in the inductance of the induction coil. This is possible for all described forms of embodiment of the switching device in which the inductance of the coil changes measurably during an actuation of the switch, for example if in this case the ferrite core is immersed deeper into the coil or its position relative to the coil changes significantly.

This enables a separate mechanical switch for detection of the sensing element actuation to be dispensed with.

In accordance with another aspect of the invention, in a method for actuating an electronic immobilizer of a vehicle which includes a described switching device, an actuation of the movable sensing device of the switching device is determined by a measurement of the change in resistance at the sliding contact. In this case too no mechanical switch need be provided.

In accordance with a further aspect of the invention, in a method for actuating an electronic immobilizer of a vehicle which includes a described switching device, a first induction coil communicates with a second induction coil and the second induction coil with a transponder integrated into a portable device. This method makes it possible to accommodate the second coil communicating directly with the transponder at a position of the sensing device which is particularly favorable for the transponder and in this way allows an ideal signal transmission. Since such a position may possibly not be easily accessible for direct power supply, said supply is undertaken inductively via the first coil.

In this form of embodiment, although a number of coils must be provided, a greater degree of design freedom is obtained thereby and the transmission between coil and transponder is improved.

Exemplary embodiments of the invention are explained in greater detail below with reference to the enclosed figures.

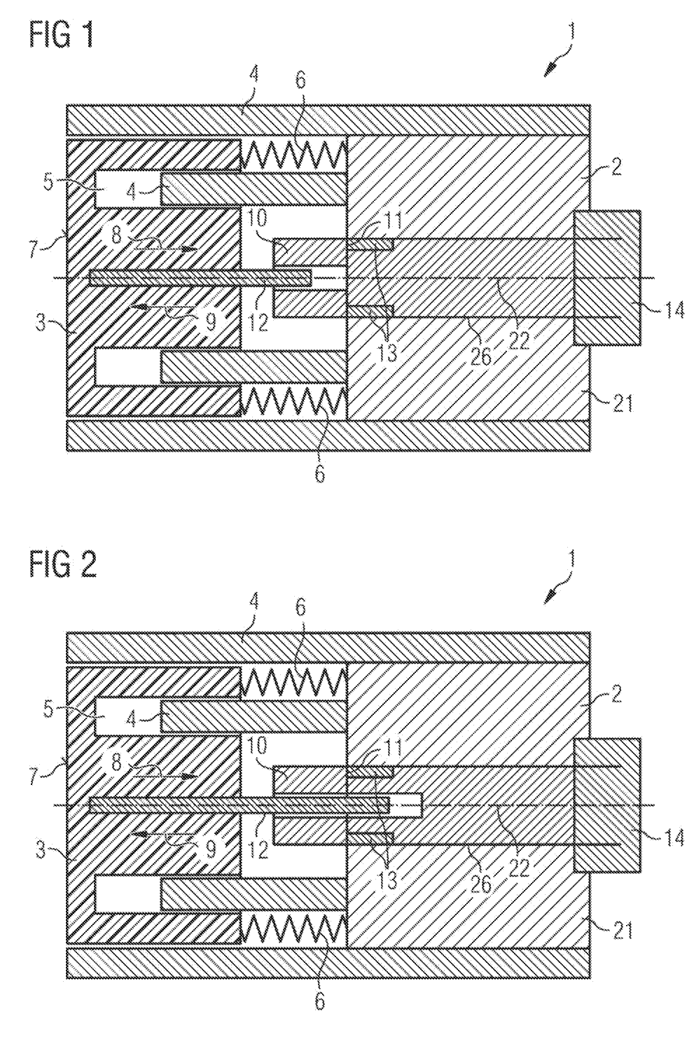

FIG. 1 shows a schematic diagram of a first form of embodiment of the inventive switching device;

FIG. 2 shows a schematic diagram of a second form of embodiment of the switching device;

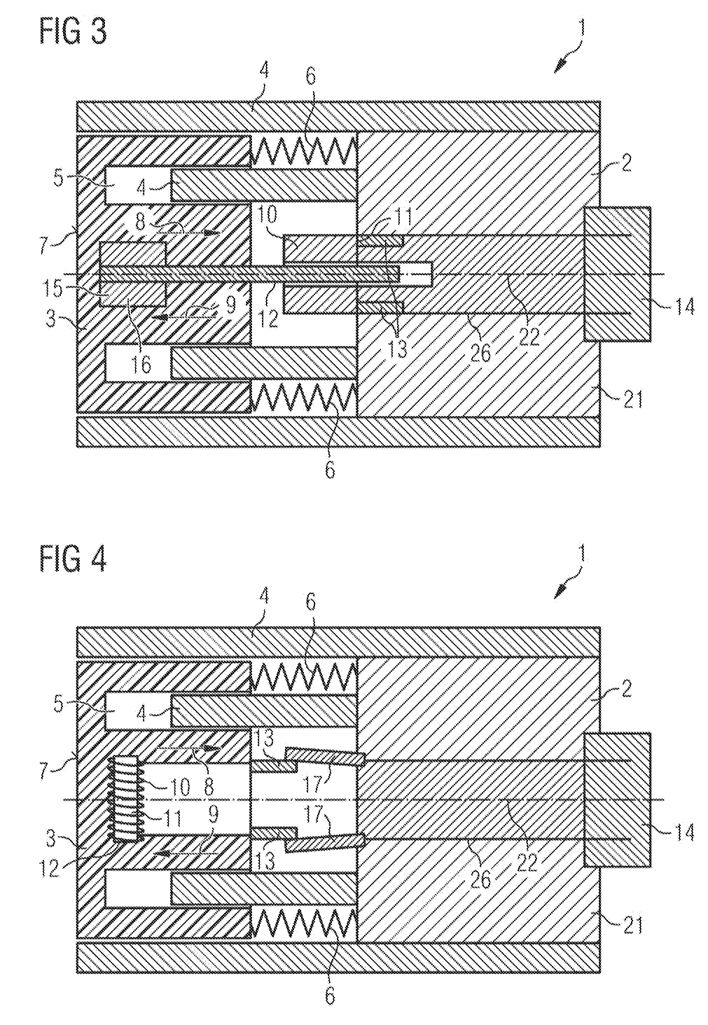

FIG. 3 shows a schematic diagram of a third form of embodiment of the switching device;

FIG. 4 shows a schematic diagram of a fourth form of embodiment of the switching device;

FIG. 5 shows a schematic diagram of a fifth form of embodiment of the switching device;

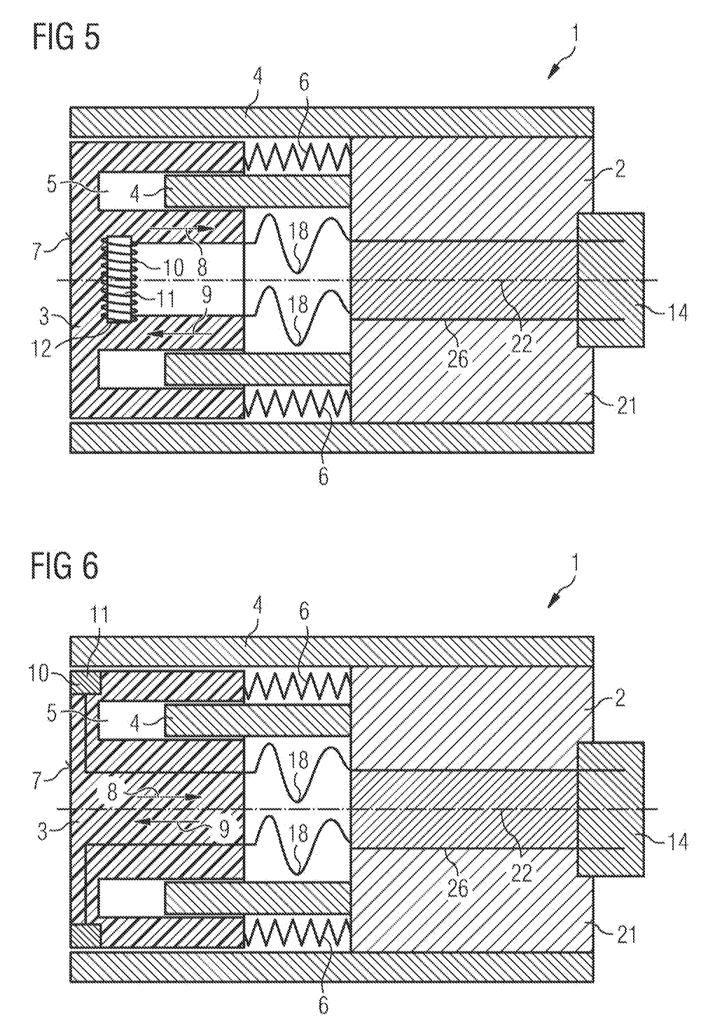

FIG. 6 shows a schematic diagram of a sixth form of embodiment of the switching device;

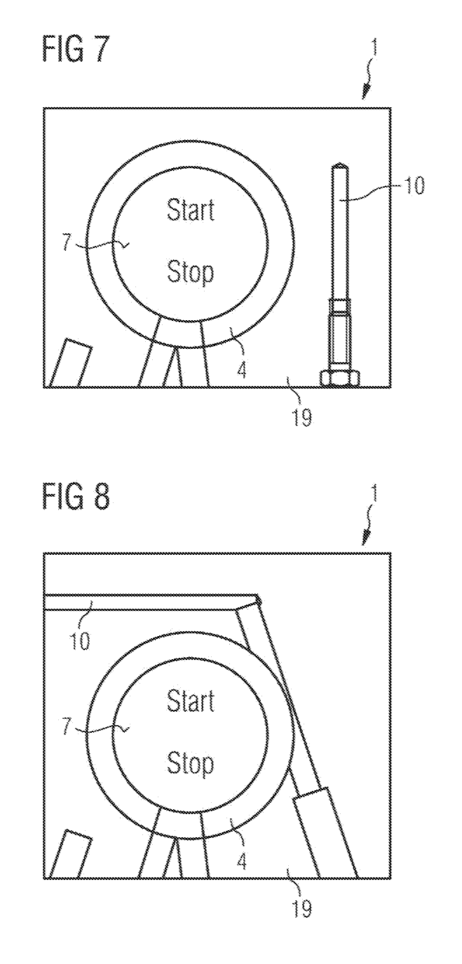

FIG. 7 shows a schematic diagram of a seventh form of embodiment of the switching device;

FIG. 8 shows a schematic diagram of an eighth form of embodiment of the switching device;

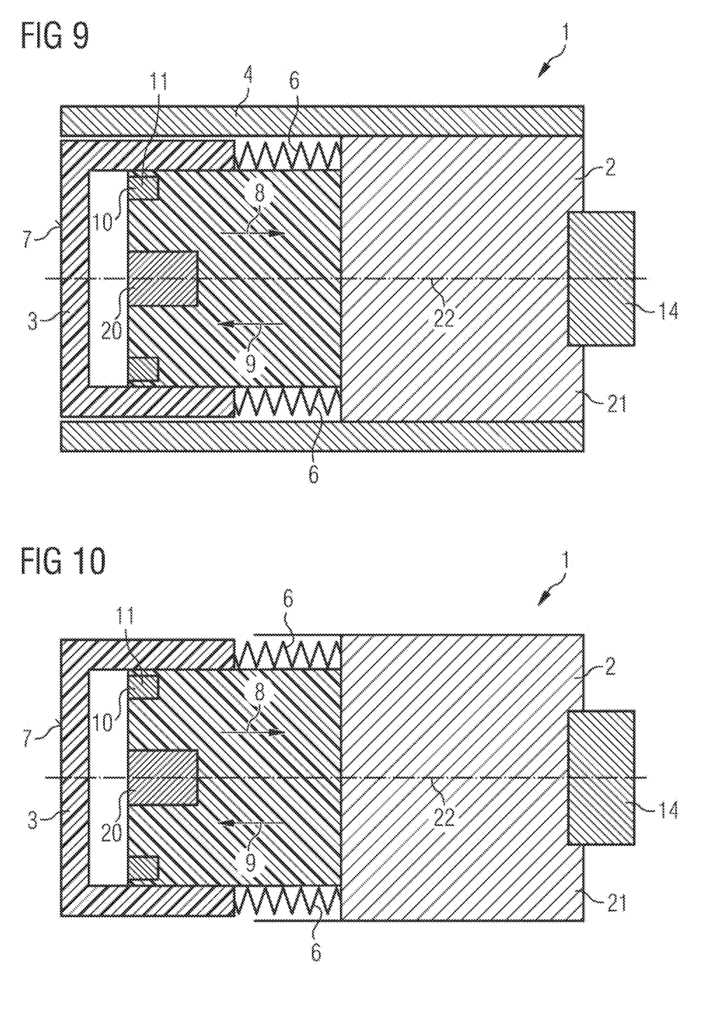

FIG. 9 shows a schematic diagram of a ninth form of embodiment of the switching device;

FIG. 10 shows a schematic diagram of a tenth form of embodiment of the switching device;

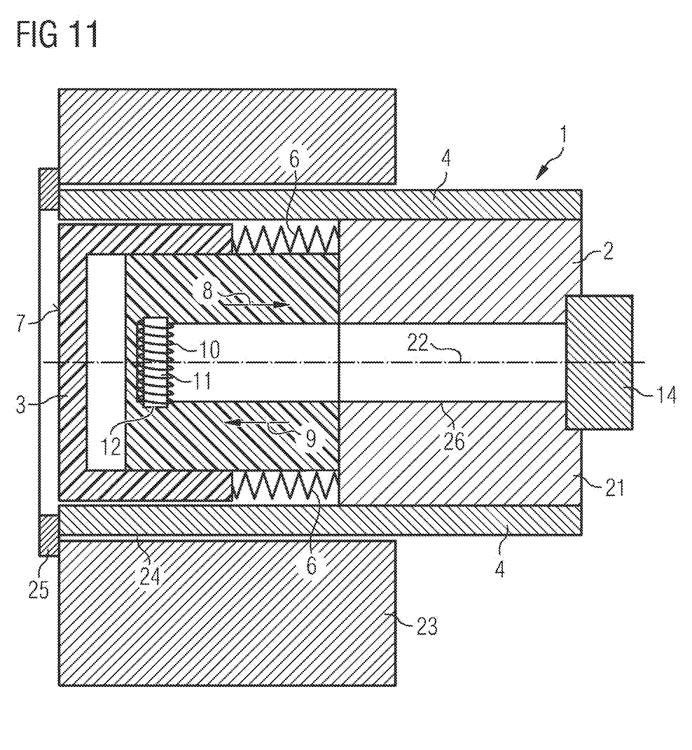

FIG. 11 shows a schematic diagram of an eleventh form of embodiment of the switching device and

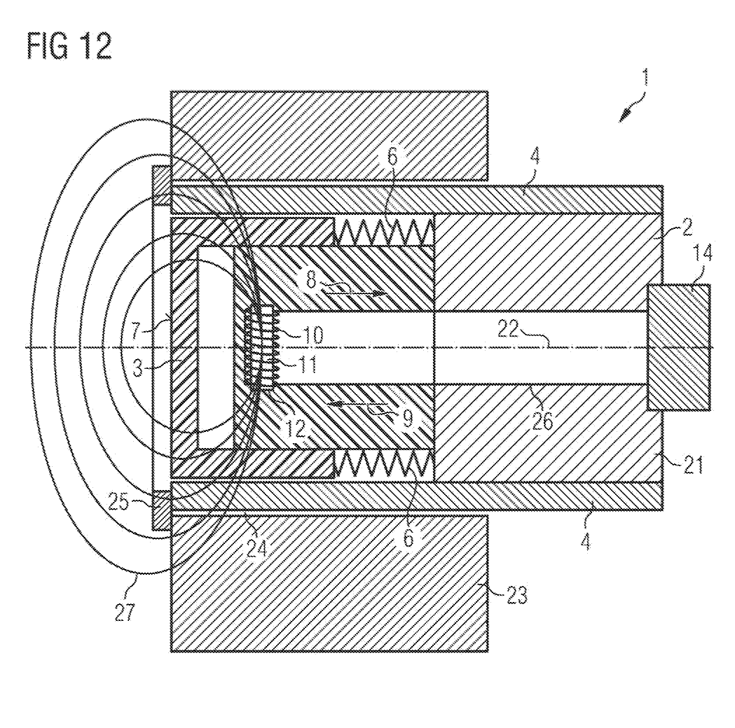

FIG. 12 shows a schematic diagram of the field strength distribution of the electromagnetic field for the eleventh form of embodiment.

The same parts are provided with the same reference signs in all figures and are not explained again.

The switching device 1 in accordance with FIG. 1 is intended to handle an authentication process of an electronic immobilizer of a vehicle and especially to undertake communication with a transponder which is accommodated in a portable device, for example a vehicle key, and which is not shown in the figures.

The switching device 1 has a fixedly mounted or fixedly mountable part 2 relative to the vehicle and a sensing element 3 which can move relative thereto. The fixedly mounted part 2 in this form of embodiment has lateral guides 4, some of which interact with recesses 5 in the sensing device 3.

The sensing device 3 is able to be moved by pressing on its sensing device surface 7 in the direction of the arrow 8 in parallel to the axis of symmetry 22 of the switching device and is spring-loaded by the springs 7 which exert a return force in the direction of the arrow 9. An operator wishing to actuate the switching device 1 does this by pressing on the sensing device surface 7.

The switching device 1 has an induction coil 10 with a coil bobbin 11 with windings and with a coil core 12. The coil bobbin 11 is connected rigidly to the fixedly mounted part 2 and the coil core 12 to the sensing device which can move 3. The windings of the coil bobbin 11 are supplied with electric current via contact pins 13, wires 26 and a plug connection 14.

The coil core 12 is immersed only partly into the coil bobbin 11 in the non-actuated position of the sensing device 3 shown. On actuation of the sensing device 3 this is moved in the direction of the arrow 8 and the coil core 12 is immersed deeper into the coil bobbin 11. The change in inductance of the coil 10 caused by this can be measured and used as a trigger signal for the authentication process and especially for communication with the transponder.

The transponder which, depending on the embodiment, has no internal energy supply of its own, is supplied inductively via the coil with power which transmits a supply signal for the transponder in response to the trigger signal. The induction coil 10 also sends useful signals to request an identification code to the transponder and receives from the transponder transmitted useful signals such as the identification code. This is subsequently compared with a previously saved identification code for authentication in a control unit (not shown) which for example can be accommodated in a rear part 21 of the switching device 1 or separately outside the switching device 1.

FIG. 2 shows the switching device 1 in accordance with the second form of embodiment. This form of embodiment differs from the first in that the coil core 12, even in the non-actuated initial position of the sensing device 3, already passes entirely through the coil bobbin 12. With this form of embodiment too however the inductance of the coil 10 changes on actuation of the sensing device 3 since the magnetic environment of the coil 10 changes. The change in inductance, although it may possibly not be so great as with the first form of embodiment, is however still measurable and can be used as a trigger signal. The second form of embodiment has the advantage of being able to be constructed in a more compact manner than the first.

FIG. 3 shows the switching device 1 in accordance with a third form of embodiment. This form of embodiment differs from the second in that, in addition to the first induction coil 10, a second induction coil 15 is provided which has its own coil bobbin 16 but which shares the coil core 12 with the first induction coil 10. The first coil 10 and the second coil 15 can thus communicate with each other and exchange both supply and also useful signals.

In this arrangement the second coil 15 is supplied with power inductively via the first coil 10. Its coil bobbin 1 can thus be arranged in the sensing device which can move 3 without this being problematic for its contacting. This has the advantage that the second coil 15 can be provided for direct communication with the transponder and this can be disposed as close as possible in the vicinity of the sensing device surface 7.

FIG. 4 shows the switching device 1 in accordance with a fourth form of embodiment. In this form of embodiment only one coil 10 is provided and both the coil bobbin 11 and also the coil core 12 of the coil 10 are arranged in the sensing device 3 which can be moved. The problem of contacting is resolved by sliding contacts 17 being provided which make contact through the contact pins 13. In this form of embodiment an electrical contact between contact pins 13 and sliding contact 17 is also already established in the non-actuated initial position of the sensing device 3. The arrangement can however also be designed so that a contact is only established on actuation of the sensing device 3. In each case the sensing device 3 can be actuated using a resistance measurement which provides the trigger signal.

In the fourth form of embodiment in accordance with FIG. 4 the coil 10, by contrast with the previously discussed forms of embodiment, is arranged with its longitudinal axis at right angles to the axis of symmetry 22 of the switching device 1 and thereby to the direction of movement of the sensing device 3. The advantage of this is that an undesired coupling of the electromagnetic field of the coil 10 with annular magnetic elements in the environment of the switching device 1, such as chrome rings for example, can be avoided through the field geometry.

FIG. 5 shows the switching device 1 in accordance with a fifth form of embodiment. This differs from the fourth form of embodiment in that the electrical contact with the coil 10 arranged in the movable sensing device 3 is made via flexible wires 18.

FIG. 6 shows the switching device 1 in accordance with a sixth form of embodiment. This differs from the fifth form of embodiment in that the coil 10 is arranged in the form of a ring in the sensing device surface 7 so that its axis of symmetry lies in parallel to the axis of symmetry 22 of the switching device 1. As already discussed, such a coil generates a different field progression from a coil arranged at right angles to the axis of symmetry 22. Which arrangement is suitable in individual cases and allows the best communication with the transponder depends on the environment of the switching device 1 in the installed state and on the geometry of the transponder and its coil.

With the form of embodiment shown in FIG. 6 the coil 10 has no coil core. The same arrangement is however also conceivable with a coil core.

FIGS. 7 and 8 show further exemplary embodiments of the switching device 1 in which the coils 10 are not integrated into the sensing device 3 or the fixed part 2.

In the seventh form of embodiment in accordance with FIG. 7 the coil 10 is arranged alongside the sensing device 3 with the sensing device surface 7. Although the coil 10 is indicated in the drawing, under normal circumstances it is hidden by a cover.

In the eighth form of embodiment in accordance with FIG. 8 the coil 10 is arranged above the sensing device 3. In this arrangement too the coil 10 is typically hidden and not visible from the outside.

These exemplary embodiments have the advantage that the entire switching device, including the coil, is integrated into a single housing 19 but that a very high degree of design freedom is retained since the coil 10 does not have to be directly integrated into the sensing device 3 or the fixed part 2.

FIG. 9 shows the switching device 1 in accordance with a ninth exemplary embodiment. In this exemplary embodiment the coil 10 is not integrated into the movable sensing device 3, but is integrated into the fixed part 2. In the form of embodiment shown it is embodied in a ring shape and without a coil core. An integration of the coil 10 and especially of the coil bobbin 11 into the fixed part 2 has the advantage that electrical contacting does not present a problem.

In the form of embodiment shown an illumination device 20 is additionally provided for in the fixedly mounted part 2 which illuminates the sensing device surface 7 from within. In this way the actuation state of the sensing device 3 can be optically displayed to a user. This type of illumination can also be provided in the other forms of embodiment in which it is not shown additionally.

The trigger signal is typically provided in the ninth form of embodiment through the actuation of a mechanical switch not shown in the figure by the pressed-in sensing device 3.

FIG. 10 shows the switching device in accordance with a tenth form of embodiment. This form of embodiment differs from the ninth in that no lateral guides 4 are provided. However of the cup-shaped embodiment of the sensing device 3 already ensures a degree of guidance so that additional stabilizing guides can be dispensed with if installation in an especially small space is required.

FIG. 11 shows the switching device 1 in accordance with an eleventh form of embodiment. This differs from the ninth in that the coil 10 is arranged with its longitudinal axis at right angles to the axis of symmetry 22 of the switching device 1 and thereby to the direction of movement of the sensing device 3.

FIG. 11 also shows the surroundings of the built-in switching device 1 in the vehicle. The switching device 1 is built into the dashboard 23 and any possible space 24 between the lateral guides 4 and the dashboard 23 is covered by a chromed annular decorative strip 25.

FIG. 12 shows a schematic diagram of the field strength distribution of the electromagnetic field during operation of the coil 10 in an arrangement in accordance with the eleventh form of embodiment. The course of the field lines 27 of the coil 10 arranged with its longitudinal axis at right angles to the axis of symmetry 22 is such that an undesired coupling, to the chrome annular decorative strip 25 for example, is only slight, so that a good signal transmission which is as error-free as possible is guaranteed.

### LIST OF REFERENCE SIGNS

1 Switching device
2 Fixedly mounted part
3 Sensing device which can move
4 Guides
5 Recesses
6 Spring
7 Sensing device surface
8 Arrow
9 Arrow
10 Induction coil
11 Coil bobbin
12 Coil core
13 Contact pin
14 Plug-in connection
15 Second induction coil
16 Coil bobbin
17 Sliding contacts
18 Flexible wire
19 Housing
20 Illumination device
21 Rear part
22 Axis of symmetry
23 Dashboard
24 Space
25 Decorative strip
26 Wires
27 Field lines

1-22. (canceled)

23. A switching device for a vehicle with an electronic immobilizer, the switching device comprising:
at least one fixedly mounted part fixedly mounted to the vehicle;
at least one movable sensing device movably disposed relative to said at least one fixedly mounted part;
at least one induction coil provided for communication with a transponder integrated into a portable device, said induction coil being at least partially integrated into said movable sensing device.

24. The switching device according to claim 23, wherein said induction coil has a coil core and a coil bobbin with windings, and wherein:
said coil core is integrated in said movable sensing device and said coil bobbin is integrated in said fixedly mounted part; or
said coil bobbin is integrated in said movable sensing device and said coil core is integrated in said fixedly mounted part.

25. The switching device according to claim 24, wherein said coil core is a ferrite core.

26. The switching device according to claim 24, with said coil core and said coil bobbin are disposed relative to each other such that a depth of immersion of said coil core into said coil bobbin changes on actuation of said sensing device.

27. The switching device according to claim 23, wherein said induction coil is one of a first induction coil and a second induction coil, said first induction coil is integrated in said fixedly mounted part and has energy supplied thereto via an electrical contact, and said second induction coil is integrated in said movable sensing device and is powered through said first induction coil.

28. The switching device according to claim 27, wherein said first induction coil and said second induction coil share a common coil core.

29. The switching device according to claim 23, wherein said induction coil is integrated in said movable sensing device and is disposed to receive an energy supply via at least one sliding contact.

30. The switching device according to claim 23, wherein said induction coil is integrated in said movable sensing device and is connected to be powered via flexible wires.

31. The switching device according to claim 30, wherein said induction coil is formed with a coil core and a coil bobbin with windings.

32. The switching device according to claim 31, wherein said coil bobbin is formed with a spring providing a return force moving said movable sensing device after an actuation thereof back into an initial position.

33. The switching device according to claim 23, wherein said movable sensing device is disposed to actuate a switch to power said induction coil on being moved.

34. The switching device according to claim 23, wherein said movable sensing device is spring-loaded in an actuation position thereof.

35. The switching device according to claim 23, which comprises lateral guides for said movable sensing device.

36. A switching device for a vehicle with an electronic immobilizer, the switching device comprising:
at least one fixedly mounted part fixedly mounted in relation to the vehicle;
at least one movable sensing element movable relative to said fixedly mounted part, said movable sensing element having a section surrounding said fixedly mounted part; and
at least one induction coil integrated in said fixedly mounted part and configured for communication with a transponder integrated in a portable device.

37. The switching device according to claim 36, wherein said movable sensing device is movable along a given direction of movement and an axis of symmetry of said induction coil lies parallel to the direction of movement of said movable sensing device.

38. The switching device according to claim 36, wherein said movable sensing device is movable along a given direction of movement and an axis of symmetry of said induction coil extends perpendicularly to the direction of movement of said movable sensing device.

39. A switching device for a vehicle with an electronic immobilizer, the switching device comprising:
at least one fixedly mounted part fixedly mounted relative to the vehicle;
at least one movable sensing device movable relative to said fixedly mounted device;
at least one induction coil configured for communication with a transponder integrated in a portable device; and
a common housing having integrated therein said induction coil, said fixedly mounted part, and said movable sensing device, with said induction coil being disposed adjacent said fixedly mounted part and said movable sensing device.

40. The switching device according to claim 39, wherein said movable sensing device is disposed to actuate a switch to power said induction coil on being moved.

41. The switching device according to claim 39, wherein said movable sensing device is spring-loaded in an actuation position thereof.

42. The switching device according to claim 39, which comprises lateral guides for said movable sensing device.

43. A vehicle, comprising an electronic immobilizer and a switching device according to claim 23.

44. A method for actuating an electronic immobilizer of a vehicle, the method which comprises:
providing the vehicle with a switching device according to claim 23;
measuring an inductance in the induction coil; and
determining that the movable sensing device has been actuated on detecting a change in the inductance of the induction coil.

45. A method for actuating an electronic immobilizer of a vehicle, the method which comprises:
providing the vehicle with a switching device according to claim 29;
measuring a resistance at the sliding contact; and
determining that the movable sensing device has been actuated on detecting a change in the resistance at the sliding contact.

46. A method for actuating an electronic immobilizer of a vehicle, the method which comprises:
providing the vehicle with a switching device according to claim 27;
wherein the first induction coil communicates with the second induction coil and the second induction coil communicates with a transponder integrated into a portable device.
